(19) United States
(12) Patent Application Publication
(10) Pub. No.: US 2021/0006830 A1
(43) Pub. Date: Jan. 7, 2021

(54) METHOD FOR PROCESSING IMMERSIVE VIDEO AND METHOD FOR PRODUCING IMMERSIVE VIDEO

(71) Applicant: ELECTRONICS AND TELECOMMUNICATIONS RESEARCH INSTITUTE, Daejeon (KR)

(72) Inventors: Kug Jin YUN, Daejeon (KR); Jun Young JEONG, Seoul (KR); Gwang Soon LEE, Daejeon (KR); Hong Chang SHIN, Daejeon (KR); Ho Min EUM, Daejeon (KR); Sang Woon KWAK, Daejeon (KR)

(73) Assignee: ELECTRONICS AND TELECOMMUNICATIONS RESEARCH INSTITUTE, Daejeon (KR)

(21) Appl. No.: 16/823,617

(22) Filed: Mar. 19, 2020

(30) Foreign Application Priority Data
Mar. 19, 2019 (KR) 10-2019-0031450
Jul. 1, 2019 (KR) 10-2019-0079025
Jul. 4, 2019 (KR) 10-2019-0080890
Jan. 13, 2020 (KR) 10-2020-0004444
Mar. 19, 2020 (KR) 10-2020-0033735

(51) Int. Cl. H04N 19/597; H04N 19/176; H04N 19/167; H04N 13/178; H04N 13/161

(52) U.S. Cl. CPC H04N 19/597; H04N 19/176; H04N 2013/0088; H04N 13/178; H04N 13/161; H04N 19/167

(57) ABSTRACT

Disclosed herein is an immersive video processing method. The immersive video processing method may include classifying a multiplicity of source view videos into base view videos and additional view videos, generating residual data for the additional view videos, packing a patch, which is generated based on the residual data, into an altas video, and generating metadata for the patch.

### CROSS REFERENCE TO RELATED APPLICATION

The present application claims priority to KR10-2019-0031450, filed 2019 Mar. 19, KR10-2019-0079025, filed 2019 Jul. 1, KR10-2019-0080890, filed 2019 Jul. 4, KR10-2020-0004444, filed 2020 Jan. 13, and KR 10-2020-0033735, filed 2020 Mar. 19, the entire contents of which are incorporated herein for all purposes by this reference.

### BACKGROUND

### Field

The present invention relates to a processing/synthesizing method for an immersive video supporting motion parallax for rotational and translational motions.

### Description of Related Art

Virtual reality service evolves towards maximizing senses of immersion and realism by generating an omni-directional video in realistic or CG (Computer Graphics) format and reproducing the video on an HMD (Head Mounted Display), a smart phone and the like. It is currently known that 6 DoF (Degrees of Freedom) needs to be supported in order to play a natural and highly immersive omni-directional video through an HMD. A 6 DoF video provided on an HMD should be a free video in six directions including (1) the horizontal movement, (2) the vertical rotation, (3) the vertical movement and (4) the horizontal rotation. However, most omni-directional videos based on real images are currently supporting only rotational movements. Therefore, researches on such technical fields as the acquisition and reproduction of 6 DoF omni-directional videos are actively under way.

### SUMMARY

For providing a large-capacity immersive video service supporting motion parallax, the present invention aims to provide a file format enabling video reproduction that supports motion parallax only by transmitting as small a video and metadata as possible.

Also, the present invention aims to enable selective encoding/decoding according to apparatus capacity by setting an order of priority among atlas videos.

Also, the present invention aims to provide a method of minimizing residual data by setting an order of priority among source view videos.

The technical objects of the present invention are not limited to the above-mentioned technical objects, and other technical objects that are not mentioned will be clearly understood by those skilled in the art through the following descriptions.

An immersive video processing method according to the present invention may include classifying a multiplicity of source view videos into base view videos and additional view videos, generating residual data for the additional view videos, packing a patch, which is generated based on the residual data, into an atlas video, and generating metadata for the patch. Herein, the metadata may include information for identifying a source view, which is the source of the patch, or information indicating the position of the patch in the atlas video.

An immersive video synthesizing method according to the present invention may include parsing video data and metadata from a bit stream, decoding the video data, and synthesizing a viewport video on the basis of a base view video and an atlas video generated by decoding the video data. Herein, the metadata may include information for identifying a source view of a patch included in the atlas video or information indicating the position of the patch in the atlas video.

In an immersive video processing apparatus and an immersive video synthesizing method according to the present invention, the metadata may further include a flag indicating whether or not the patch is a ROI (Region of Interest) patch.

In an immersive video processing apparatus and an immersive video synthesizing method according to the present invention, the metadata may include index information of cameras capturing the multiplicity of source view videos, and different indexes may be allocated to each of the cameras.

In an immersive video processing apparatus and an immersive video synthesizing method according to the present invention, when a multiplicity of atlas videos is generated, the metadata may include priority information of the atlas videos.

In an immersive video processing apparatus and an immersive video synthesizing method according to the present invention, the metadata may include information indicating positions where ROI patches in the atlas videos are packed.

In an immersive video processing apparatus and an immersive video synthesizing method according to the present invention, the metadata may include at least one of a flag indicating whether or not the atlas videos are scaled or information indicating the size of the atlas videos.

In an immersive video processing apparatus and an immersive video synthesizing method according to the present invention, when a multiplicity of atlas videos is encoded, the flag may be encoded for each of the atlas videos.

The features briefly summarized above with respect to the present invention are merely exemplary aspects of the detailed description below of the present invention, and do not limit the scope of the present invention.

According to the present invention, a file format may be provided which enables video reproduction supporting motion parallax by transmitting as small a video and metadata as possible.

According to the present invention, since an order of priority is set among atlas videos, selective encoding/decoding according to apparatus capacity may be possible.

According to the present invention, since an order of priority is set among source view videos, residual data may be minimized.

Effects obtained in the present invention are not limited to the above-mentioned effects, and other effects not mentioned above may be clearly understood by those skilled in the art from the following description.

### BRIEF DESCRIPTION OF THE DRAWINGS

FIG. 1 is a view illustrating an immersive video that may provide motion parallax.

FIGS. 2A and 2B are views illustrating a multiplicity of source view videos according to the present invention.

FIG. 3 is a view illustrating a conceptual diagram for generating an immersive video by synthesizing a multiplicity of source view videos.

FIG. 4 is a block diagram of an immersive video processing apparatus according to an embodiment of the present invention.

FIG. 5A to FIG. 7 are views illustrating examples of generating residual data for an additional view video.

FIG. 8 is a block diagram of an immersive video output apparatus according to the present invention.

FIG. 9 is a flowchart illustrating a method of generating residual data of a source view video according to an embodiment of the present invention.

FIG. 10 is a view for explaining an example of discriminating duplicate data between a source view video and a reference video.

FIG. 11 is a flowchart illustrating a process of synthesizing a viewport video.

FIG. 12 is a view illustrating an example of synthesizing a viewport video by using a base view video and patches.

FIG. 13 is a view illustrating an example of performing hierarchical pruning among additional view videos.

FIG. 14 is a view illustrating a pruning order for a ROI view video and a non-ROI view video.

FIG. 15 illustrates an example where a multiplicity of atlas videos is generated.

FIG. 16 is a view illustrating an example where an atlas video to be decoded is selected according to a priority order of atlas videos.

FIG. 17 is a view illustrating an aspect of packing ROI patches in an atlas video.

FIG. 18 is a view illustrating an example of generating a central view video.

FIG. 19 is a view illustrating a method of synthesizing additional view videos according to the present invention.

FIG. 20 is a view illustrating an example of generating a residual central view video.

### DETAILED DESCRIPTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the embodiment. The following detailed description is, therefore, not to be taken in a limiting sense, and the scope of the exemplary embodiments is defined only by the appended claims, appropriately interpreted, along with the full range of equivalents to what the claims claim.

Terms used in the present invention, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of relevant items or any one of a plurality of relevant terms.

When an element is simply referred to as being ‘connected to’ or ‘coupled to’ another element in the present description, it should be understood that the former element is directly connected to or directly coupled to the latter element or the former element is connected to or coupled to the latter element, having yet another element intervening therebetween. In contrast, when an element is referred to as being “directly coupled” or “directly connected” to another element, it should be understood that there is no intervening element therebetween.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for better understanding and ease of description. Thus, at least two constitutional parts of each constitutional part may be combined to form one constitutional part or one constitutional part may be divided into a plurality of constitutional parts to perform each function. Both an embodiment where each constitutional part is combined and another embodiment where one constitutional part is divided are also included in the scope of the present invention, if not departing from the essence of the present invention.

The terms used in the present invention are merely used to describe particular embodiments, and are not intended to limit the present invention. Singular expressions include plural expressions unless the context clearly indicates otherwise. In the present invention, it is to be understood that terms such as “include”, “have”, etc. are intended to indicate the existence of the features, numbers, steps, actions, elements, parts, or combinations thereof disclosed in the specification but are not intended to preclude the possibility of the presence or addition of one or more other features, numbers, steps, actions, elements, parts, or combinations thereof. In other words, when a specific element is referred to as being “included”, other elements than the corresponding element are not excluded, but additional elements may be included in the embodiments of the present invention or the technical scope of the present invention.

In addition, some of components may not be indispensable ones performing essential functions of the present invention but may be selective ones only for improving performance. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present specification, well-known functions or constructions will not be described in detail since they may unnecessarily obscure the understanding of the present invention. The same constituent elements in the drawings are denoted by the same reference numerals, and a repeated description of the same elements will be omitted.

An immersive video means a video that enables a viewing position of a user to dynamically change in a three-dimensional space. Immersive videos may be classified into such types as 3DoF (Degree of Freedom), 3DoF+, Windowed-6DoF and 6DoF.

A 3DoF video means a video that represents a movement of a viewport by three rotational movements (for example, yaw, roll and pitch). A 3DoF+ video means a video that adds limited translational movements to a 3DoF video. A 6DoF video means a video that represents a movement of a viewport by three rotational movements and three translational movements (for example, (x, y, z) vector).

3DoF+ videos and 6DoF videos may provide a user with motion parallax not only for a rotational movement but also limited or various translational movements (for example, left-right/up-down/front-back).

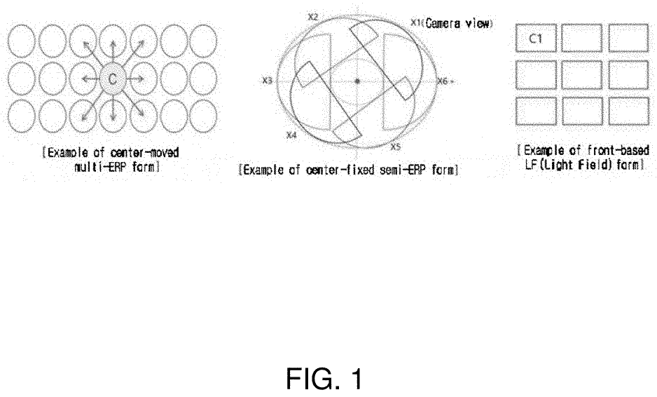

FIG. 1 is a view illustrating an immersive video that may provide motion parallax.

A 3DoF+ or 6DoF immersive video providing a user with motion parallax may include texture information and depth information. On the other hand, a 3DoF immersive video that does not provide motion parallax may consist of only texture information.

In the embodiments described below, it is assumed that an immersive video may render motion parallax like 3DoF+, Windowed-6DoF or 6DoF videos. However, the embodiments described below may also be applicable to 3DoF or similar immersive videos based on texture information. In case the embodiments described below are applied to an immersive video based on texture information, processing and representation of depth information may be omitted.

In the present invention, ‘view’ indicates a particular position like a capturing position of a camera or a viewing position of a viewer. ‘View video’ means a corresponding video to the ‘view’. For example, a view video may refer to a video captured in a particular view or a video synthesized around a particular view.

A view video may be referred to in various ways according to type or usage. For example, videos captured by each of a multiplicity of cameras may be referred to as ‘source view videos’. View videos with different views may be distinguished based on expressions like ‘first’ or ‘second’.

In the embodiments described below, according to types or purposes of view videos, such expressions like ‘source’, ‘additional’ and ‘base’ may be added in front of ‘view video’.

Hereinafter, the present invention will be described in detail.

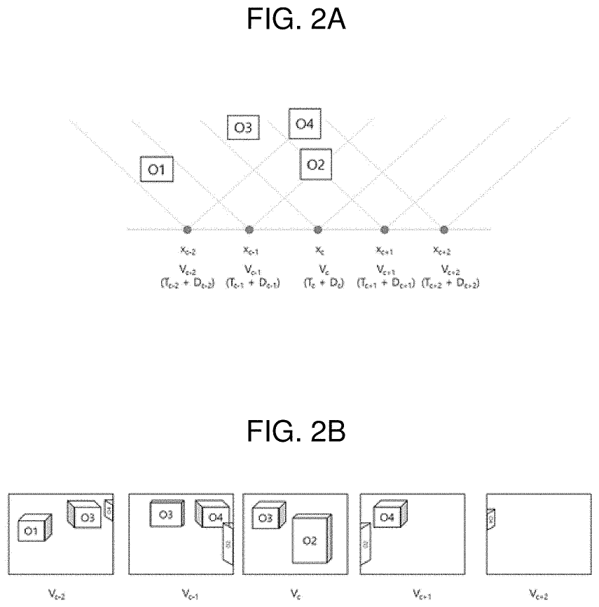

FIGS. 2A and 2B are views illustrating a multiplicity of source view videos according to the present invention.

FIG. 2A shows capturing range (view angle) of each view, and FIG. 2B shows source view videos of each view.

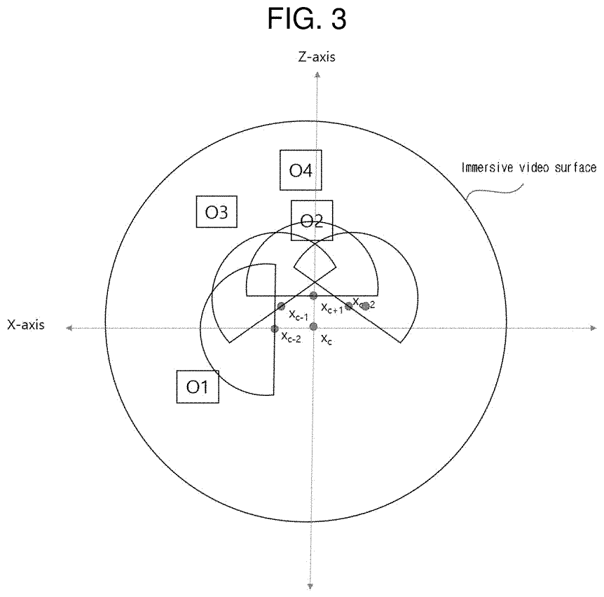

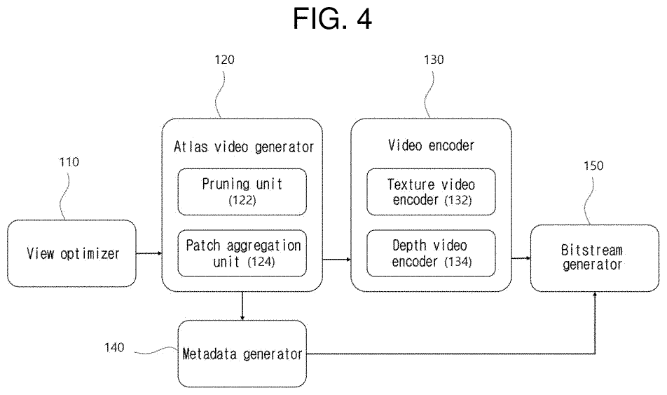

FIG. 3 is a view illustrating a conceptual diagram for generating an immersive video by synthesizing a multiplicity of source view videos.

In FIGS. 2A, 2B, and FIG. 3, xn represents a capturing view. For example, xn may represent a capturing view of a camera with the index n.

In FIGS. 2A. 2B, and FIG. 3, Vn represents a video captured based on the view xn. According to types of immersive videos, a video Vn, which is captured based on the view xn, may include a texture video and/or a depth video. For example, in the case of a 3DoF video, a video Vn may consist only of texture videos. Alternatively, in the case of a windowed-6DoF video based on a monoscopic video, a video Vn may consist only of texture videos. On the other hand, in the case of a 3DoF+ or 6DoF video, a video Vn may include a texture video and a depth video. A texture video captured based on a view xn is marked by Tₙ, and a depth video captured based on a view xn is marked by Dₙ.

Different indexes may be allocated to each source view. Information on an index of a source view may be encoded as metadata. An index allocated to each source view may be set to be the same as an index allocated to each camera.

In addition, an index allocated to a camera may be different from an index allocated to a source view. In this case, information indicating a source view corresponding to an index of a camera may be encoded as metadata.

Hereinafter, for the convenience of explanation, an index of a central view is assumed as c, and indexes of other views are assumed as (c+k) or (c−k) according to the distance to a central view or a central camera. For example, a view located on the right of a central view or an index of the view is assumed as (c+1), and an index of a view located on the right of a view with index (c+1) is assumed as (c+2). In addition, an index of a view located on the left of a central view is assumed as (c−1), and an index of a view located on the left of a view with index (c−1) is assumed as (c−2). In addition, it is assumed that an index of a source view is the same as an index of a camera.

In order to implement an immersive video, a base view video and multiview videos excluding the base view video are required. In addition, in order to implement a 3DoF+ or 6DoF-based immersive video, not only monoscopic data (for example, texture videos) but also stereoscopic data (for example, depth videos and/or camera information) are required.

For example, as illustrated in FIGS. 2A, 2B, and FIG. 3, an immersive video may be generated by synthesizing a view video V_{c} captured in a central position x_{c} and view videos V_{c-1}, V_{c-2}, V_{c+1}, and V_{c+2} captured in non-central positions.

As an immersive video is implemented based on multiview video data, an effective storage and compression technique for large video data is required for obtaining, generating, transmitting and reproducing an immersive video.

The present invention provides an immersive video generation format and compression technique that can store and compress a 3DoF+ or 6DoF immersive video supporting motion parallax while maintaining compatibility with a 3DoF-based immersive video.

FIG. 4 is a block diagram of an immersive video processing apparatus according to an embodiment of the present invention.

Referring to FIG. 4, an immersive video processing apparatus according to the present invention may include a view optimizer 110, an atlas video generator 120, a metadata generator 130, a video encoder 140 and a bit stream generator 150.

A view optimizer 110 classifies a multiplicity of source view videos into base view videos and non-base view videos. Specifically, a view optimizer 110 may select at least one among a multiplicity of source view videos as a base view video.

A view optimizer 110 may determine a base view video on the basis of a camera parameter. Specifically, a view optimizer 110 may determine a base view video on the basis of a camera index, an order of priority among cameras, a camera position or whether or not a camera is a ROI camera.

For example, a view optimizer 110 may determine a source view video captured through a camera with a smallest (or largest) camera index, a source view video captured through a camera with a predefined index, a source view video captured through a camera with a highest (lowest) priority, a source view video captured through a camera in a particular position (for example, central position) or a source view video captured through a ROI camera as a base view video.

Alternatively, a view optimizer 110 may select a base view video on the basis of the qualities of source view videos. For example, a view optimizer 110 may select a source view video with the best quality among source view videos as a base view video.

Alternatively, a view optimizer 110 may examine a degree of duplication among source view videos and select a base view video on the basis of a descending (or descending) order of duplicate data with other source view videos.

Alternatively, a view optimizer 110 may select a base view video on the basis of data (for example, metadata) input from outside. Data input from outside may include at least one among an index specifying at least one among a multiplicity of cameras, an index specifying at least one among a multiplicity of capturing views, and an index specifying at least one among a multiplicity of source view videos.

A source view video that is not selected as a base view video may be referred to as an additional view video or a non-base view video.

A multiplicity of source view videos may also be selected as base view videos.

An atlas video generator 120 may generate residual data of an additional view video by subtracting a base view video from the additional view video and then may generate an atlas video based on the residual data.

An atlas video generator 120 may include a pruning unit 122 and a patch aggregation unit 124.

A pruning unit 122 performs pruning for an additional view video. Pruning may be intended to remove duplicate data with a base view video within an additional view video. As a result of pruning, residual data for an additional view video may be generated.

Source view videos generated by capturing the same object in different views may have common data. Accordingly, when a base view video is subtracted from an additional view video, data that are not included in a source view video may be generated as residual data for the additional view video.

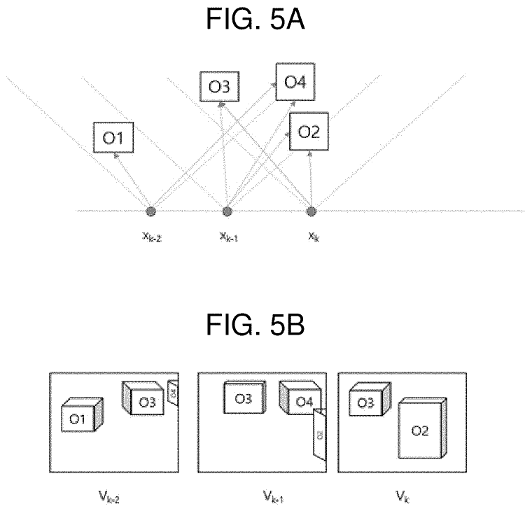

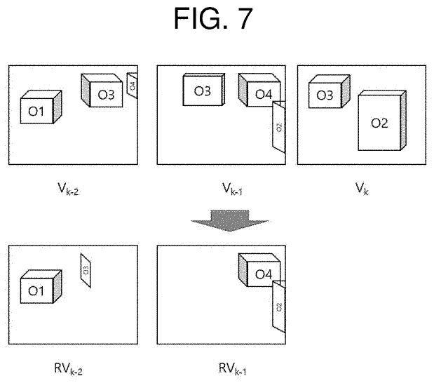

FIG. 5A to FIG. 7 are views illustrating examples of generating residual data for an additional view video.

In the example illustrated in FIGS. 5A and 5B, Vn represents a video captured in a view xn. For the convenience of explanation, a base view video is assumed to be Vₖ.

In a windowed-6DoF video based on a monoscopic video, a base view video may be a 2D video. On the other hands, in a 3DoF+ or 6DoF video based on an omni-directional video, a base view video may be a 3D or 3DoF video including a texture video and a depth video.

In the example illustrated in FIG. 5A, the arrows of solid lines indicate data included by a base view video Vₖ. A view angle of a view xₖ includes objects O2, O3 and O4. Here, since the object O4 is blocked by the object O3, the data for the object O4 are not included in a base view video Vₖ, as in the example illustrated by FIG. 5B.

In the example illustrated in FIG. 5A, the arrows of dotted lines indicate data that are included not in a base view video but in an additional view video. A view angle of a view xₖ₋₁ includes objects O2, O3 and O4. As data for the objects O2 and O3 are also included in a base view video Vₖ, some duplicate data may exist for the objects O2 and O3 between an additional view video Vₖ₊₁ and the base view video Vₖ. On the other hands, data for the object O4 are not included in the base view video Vₖ.

A view angle of a view xₖ₊₂ includes objects O1, O3 and O4. As data for the object O3 are also included in a base view video Vₖ, some duplicate data may exist for the object O3 between an additional view video Vₖ₋₂ and the base view video Vₖ. On the other hands, data for the objects O1 and O4 are not included in the base view video Vₖ.

Residual data for an additional view video may be generated by subtracting a base view video from the additional view video.

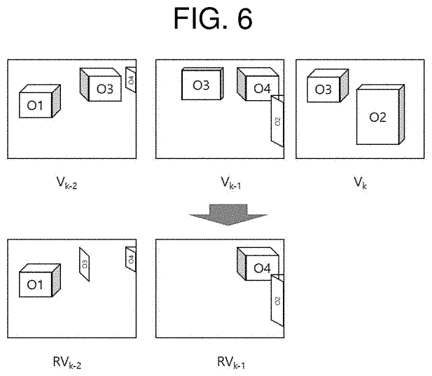

For example, by subtracting a base view video Vₖ from an additional view video Vₖ₋₁, a residual video RVₖ₋₁ for the additional view video Vₖ₋₁ may be generated. In the example illustrated in FIG. 6, a residual video RVₖ₋₁ is illustrated to include some data for the object O2, which is not included in a base view video Vₖ, and data for the object O4. Since data for the object O3 included in an additional view video Vₖ₊₁ are all included in a base view video Vₖ, it may be understood that the data are not included in a residual video Rvₖ₊₁.

Likewise, by subtracting a base view video Vₖ from an additional view video Vₖ₋₂, a residual video RV_{K-2} for the additional view video Vₖ₋₂ may be generated. In the example illustrated in FIG. 6, a residual video Rvₖ₋₂ is illustrated to include some data for the object O2, which is not included in a base view video Vₖ, some data for the object O3, data for the object O1, and data for the object O4.

When a source view video includes both a texture video and a depth video, pruning may be performed the texture video and the depth video respectively. In consequence, residual data for an additional view video may include at least one of residual data for a texture video or residual data for a depth video.

For example, in the case of a 3DoF+ or 6DoF-based immersive video, a residual video RVₖ₋ₙ may include a texture residual video RTₖ₋ₙ and a depth residual video RDₖ₋ₙ.

Alternatively, pruning may be performed only for a depth video, and a texture residual video may be generated based on a depth residual video.

For example, by subtracting a depth video of a base view video from a residual video of an additional view video, a depth residual video for the additional view video may be generated, and a mask image may be generated based on the generated depth residual video. The mask image indicates a depth residual video where a pixel value is 1 in a region having residual data and a pixel value is 0 in the remaining region. A residual video for an additional view video may be obtained by masking a generated mask image to a texture video of the additional view video.

In case there is a multiplicity of base view videos, residual data for an additional view video may be generated by subtracting each of the multiplicity of base view videos from the additional view video. Alternatively, residual data for an additional view video may be generated by selecting at least one among a multiplicity of base view videos and subtracting the selected base view video from the additional view video.

In case residual data are generated by removing duplicate data between an additional view video and a base view video, duplicate data between additional view videos are not removed, which is problematic. For example, as illustrated in FIG. 6, both a residual video RVₖ₋₁ of an additional view video Vₖ₋₁ and a residual video Rvₖ₋₂ of an additional view video Vₖ₋₂ include common data for the object O4.

In order to remove duplicate data among additional view videos, pruning may be performed for at least some of additional videos by using a basic view video and other additional view videos. Thus, residual data of an additional view video may be generated by removing duplicate data with a basic view video and duplicate data with another additional view video.

For example, a residual video RVₖ₋₂ for an additional view video Vₖ₋₂ may be generated by subtracting a base view video Vₖ and an additional view video Vₖ₋₁ from an additional view video Vₖ₋₂ or by subtracting the base view video Vₖ and a residual video RVₖ₊₁ of the additional view video Vₖ₋₁ from the additional view video Vₖ₋₂. Thus, in the example illustrated in FIG. 6, a residual video RVₖ₋₂ for an additional view video Vₖ₋₂ is illustrated to have removed data for the object O4 included in a residual video RVₖ₋₁.

As described above, an additional view video having duplicate data with another additional view video may be defined as a shared view video. For example, an additional view video Vₖ₋₂ having duplicate with another additional view video Vₖ₋₁ may be a shared view video of the additional view video Vₖ₋₁. Pruning of a shared view video may be performed by using an additional view video having common data with a shared view video.

A view video used for generating residual data or a view video necessary for video synthesis may be referred to as a reference view video. For example, for a shared view video Vₖ₋₂, a basic view video Vₖ and an additional view video Vₖ₋₁ may function as reference view videos. Particularly, an additional view video used as a reference view video of another additional view video may be referred to as an additional reference view video.

An order of pruning priority may be set among additional view videos. According to an order of pruning priority among additional view videos, it may be determined whether or not another additional view video is used. A higher priority indicates earlier pruning.

For example, residual data of an additional view video with the highest priority (for example, priority 0) may be generated by subtracting a base view video from the additional view video. On the other hand, residual data of an additional view video with a lower priority (for example, priority 1) may be generated by subtracting a base view video and an additional reference view video (for example, priority 0) from the additional view video. In other words, pruning of additional view videos may be hierarchically performed.

An order of priority among additional view videos may be determined by an index difference from a base view video. For example, an order of priority among additional view videos may be determined in an ascending or descending order of an index difference from a base view video.

Alternatively, an order of priority among additional view videos may be determined by considering an amount of duplicate data with a base view video. For example, an order of priority among additional view videos may be determined in a descending or ascending order of duplicate data with a base view video.

Pruning of an additional view video with a low priority may be performed by using another additional view video next above the additional view video in priority. For example, residual data for an additional view video Vₖ₋ₙ may be generated by subtracting a base view video Vₖ and another additional view video Vₖ₋ₙ₊₀ from the additional view video Vₖ₋ₙ.

In case there is a multiplicity of additional view videos with a high priority, pruning for the additional view videos may be performed by using all or some of base view videos with a higher priority than the additional view videos. For example, for residual data for an additional view video Vₖ₋ₙ, at least one among a base view video Vₖ and a multiplicity of additional view videos ranging from Vₖ₋₁ to Vₖ₋ₙ₊₁ may be used.

Alternatively, the number of additional view videos used for pruning an additional view video may be already stored in an immersive video processing apparatus.

A patch aggregation unit 124 generates an atlas video by collecting residual data of additional view videos. Specifically, data included in a residual video may be processed into square patches, and patches extracted from a multiplicity of residual videos may be packed into a single video. A video generated by packing patches may be referred to as an atlas or an atlas video.

An atlas video may include a texture video and/or a depth video.

An atlas video generator 120 may also generate an atlas occupancy map showing an occupancy aspect of patches in an atlas video. An atlas occupancy map may be generated in the same size as an atlas video.

A pixel value of an atlas occupancy map may be set as an index value of patches in an atlas video. For example, pixels in a region (for example, a collocate region) corresponding to a region occupied by a first patch in an atlas video may be set as an index value allocated to the first patch. On the other hand, pixels in a region corresponding to a region occupied by a second patch in an atlas video may be set as an index value allocated to the second patch.

A metadata generator 130 generates metadata for view video synthesis. Specifically, a metadata generator 130 may format residual video-related additional information that is packed into an atlas.

Metadata may include various information for view video synthesis.

For example, metadata may include information of a camera. Information of a camera may include at least one of an extrinsic parameter or an intrinsic parameter of a camera. An extrinsic parameter of a camera may include information indicating a capturing position of the camera.

Metadata may include information on a source view. Information on a source view may include at least one among information on the number of source views, information specifying a camera corresponding to a source view, and information on a source view video. Information on a source view video may include information on the size or quality of a source view video.

Metadata may include information on a base view video. Information on a base view video may include at least one of information on a source view selected as a base view or information on the number of base view videos.

Metadata may include information on a priority order of pruning. Information on a priority order of pruning may include at least one among a priority order of a multiplicity of base views, a priority order among additional views and information showing whether or not an additional view is a shared view.

Metadata may include information on a priority order of videos. A priority order of videos may include at least one among a priority order among source views, a priority order among base views and a priority order among atlas videos. When a data volume is limited, at least one of whether or not a video is transmitted or a bit rate allocated to a video may be determined based on information of a priority order of videos. Alternatively, a priority order may also be determined according to view indexes of shared view videos.

Metadata may include information on an atlas video. Information on an atlas video may include at least one among information on the number of atlas videos, information on the size of an atlas video and information on patches in an atlas video. Patch information may include at least one among index information for distinguishing a patch in an atlas video, information showing a source view, which is a source of a patch, information on the position/size of a patch in an atlas video, and information on the position/size of a patch in a source view video.

A video encoder 140 encodes a base view video and an atlas video. A video encoder may include a texture video encoder 142 for a texture video and a depth video encoder 144 for a depth video.

A bit stream generator 150 generates a bit stream on the basis of an encoded video and metadata. A bit stream thus generated may be transmitted to an immersive video output apparatus.

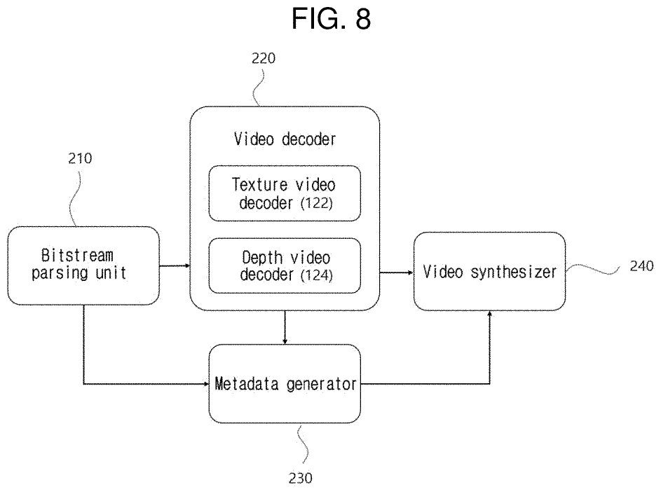

FIG. 8 is a block diagram of an immersive video output apparatus according to the present invention.

Referring to FIG. 8, an immersive video output apparatus according to the present invention may include a bit stream parsing unit 210, a video decoder 220, a metadata processor 230 and a video synthesizer 240.

A bit stream parsing unit parses video data and metadata from a bit stream. Video data may include data of an encoded base view video and data of an encoded atlas video.

A video decoder 220 decodes parsed video data. A video decoder 220 may include a texture video decoder 222 for decoding a texture video and a depth video decoder 224 for decoding a depth video.

A metadata processor 230 unformats parsed metadata.

Unformatted metadata may be used to synthesize a view video. For example, in order to synthesize a viewport video corresponding to a viewing position of a user. a metadata processor 230 may determine the position/size of necessary patches for viewport video synthesis in an atlas video by using metadata.

A video synthesizer 240 may dynamically synthesize a viewport video corresponding to a viewing position of a user. For viewport video synthesis, a video synthesizer 240 may extract necessary patches for synthesizing a viewport video from an atlas video. Specifically, based on metadata that are unformatted in a metadata processor 230, the position/size of necessary patches for viewport video synthesis in an atlas video may be determined, and patches corresponding to the determined position/size may be filtered, thereby being separated from the atlas video. When patches necessary for synthesis of a viewport video are extracted, the viewport video may be generated by synthesizing base view videos and the patches.

Specifically, after warping and/or transforming a base view video and patches into a coordinate system of a viewport, a viewport video may be generated by merging a warped and/or transformed base view video and warped and/or transformed patches.

Based on the above description, a method of generating residual data for a source view video and a view video synthesis method will be described in further detail.

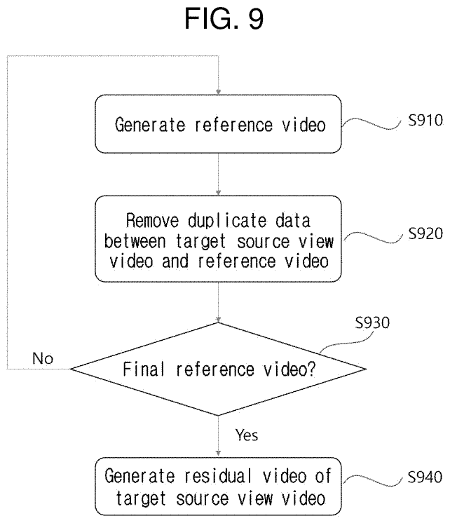

FIG. 9 is a flowchart illustrating a method of generating residual data of a source view video according to an embodiment of the present invention.

Residual data may be generated by subtracting a second source view video from a first source view video. Here, a first source view video represents an additional view video, and a second source view video represents at least one of a base view video or an additional reference view video.

In order to remove redundancy between a first source view video and a second source view video, the second source view video may be warped to the first source view video (S910). Specifically, residual data for a first source view video may be generated by warping a second source view video to the first source view that is a target view and subtracting the warped second source view video from the first source view video. A warped source view video will be referred to as a reference video.

Warping may be performed based on a 3D warping algorithm which warps a depth map of a second source view video and then also warps a texture video based on the warped depth map. Warping of a depth map may be performed based on a camera parameter. 3D warping may be performed in the following steps.

Step 1) Back projection from a source view video coordinate system to a three-dimensional space coordinate system

Step 2) Projection from a three-dimensional space coordinate system to a coordinate system of a target view video

Equation 1 shows a back projection of a coordinates of a source view video Vₖ to a three-dimensional space coordinate system.

$$[ \begin{matrix}X \\ Y \\ Z\end{matrix} ] = {P}_{K}^{- 1} \cdot [ \begin{matrix}{x}_{k} \\ {y}_{k} \\ {z}_{k}\end{matrix} ] \qquad Equation 1$$

A projection matrix P may be obtained from an intrinsic parameter K and extrinsic parameters R and T of a camera, which are obtained through a camera calibration process. Specifically, a projection matrix P may be derived based on Equation 2 below.

P=K·RT Equation 2

Equation 3 shows a projection of coordinates, which are back projected to a three-dimensional space coordinate system, to a coordinate system of a target view video Vₖ₋₁.

$$[ \begin{matrix}{x}_{k - 1} \\ {y}_{k - 1} \\ {z}_{k - 1}\end{matrix} ] = {P}_{k - 1} \cdot [ \begin{matrix}X \\ Y \\ Z\end{matrix} ] \qquad Equation 3$$

To perform 3D warping for a source view video that is a two-dimensional data array, as expressed in Equation 1 and Equation 3, a depth value corresponding to Z value may be additionally required.

As a result of warping, an unseen portion in a source view video may be left as a hole in a reference video.

A first source view video may be compared with a reference video, and duplicate data with the reference video may be removed from the first source view video (S920).

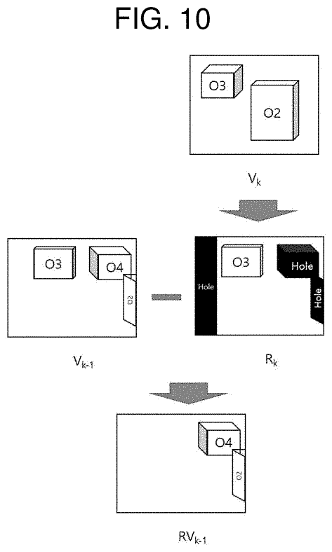

FIG. 10 is a view for explaining an example of discriminating duplicate data between a source view video and a reference video.

In order to generate residual data for a first source view video Vₖ₋₁, 3D warping for a second source view video Vₖ may be performed and thus a reference video Rₖ may be generated. Here, an unseen region in a second source view video Vₖ may be left as a hole in a reference video Rₖ. Specifically, information on an object O4 and information on the left side of an object O2, which are unseen in a second source view video Vₖ, may be left as hole.

A hole represents a region where no video data exist, and a sample value in a hole may be set to a default value (for example, 0).

A residual video RVₖ₋₁ for a first source view video Vₖ₋₁ may be generated by subtracting a reference video Rₖ from a first source view video Vₖ₋₁. Specifically, duplicate data may be detected by comparing at least one of a texture value or a depth value between a first source view video and a reference video. Specifically, when a difference of pixel value between a first source view video and a reference video is smaller than a preset threshold, a corresponding pixel may be determined as duplicate data since the pixel value are data for the same position in a three-dimensional space.

For example, as illustrated in FIG. 10, information on an object O3 in a first source view video Vₖ₋₁ and a reference video Rₖ may be determined as duplicate data.

On the other hand, a difference of pixel values between a first source view video and a reference video is equal to or greater than a preset threshold, a corresponding pixel may not be determined as duplicate data. For example, as illustrated in FIG. 10, data for an object O4 and the left side of an object O2 in a first source view video Vₖ₋₁ may not be determined as duplicate data.

Duplicate data detection may be performed by comparing pixels in the same position between a first source view video and a reference video. Alternatively, duplicate data may be detected by performing sub-sampling of pixels and then comparing pixels of the same position.

When a multiplicity of reference videos is used to generate residual data for a first source view video (S930), the reference video generation (S910) and the duplicate data removal (S920) may be repeatedly performed for each of the multiplicity of source view videos. In other words, a residual video of a first source view video may be generated by removing duplicate data for a multiplicity of reference videos (S940).

For example, if it is assumed that pruning for a first source view video is performed based on a second source view video and a third source view video, a residual video for the first source view video may be generated by using a first reference video, which is generated by warping the second source view video, and a second reference video, which is generated by warping the third source view video.

For example, as illustrated in FIG. 8, a residual video RVₖ₋₂ of a second additional view video Vₖ₋₂ may be generated by using a first reference video Rₖ, which is generated by warping a base view video Vₖ, and a second reference video Rₖ₋₁ for a first additional view video Vₖ₋₁. Here, a second reference video Rₖ₊₁ may be generated by warping a first additional view video Vₖ₋₁ or by warping a first residual video RVₖ₋₁. Accordingly, a second residual video RVₖ₋₂ may be generated by removing duplicate data between a second additional view video Vₖ₋₂ and a base view video Vₖ and duplicate data between the second additional view video Vₖ₋₂ and a first additional view video Vₖ₋₁.

Hereinafter, a method of generating a viewport video using an atlas video will be described in detail.

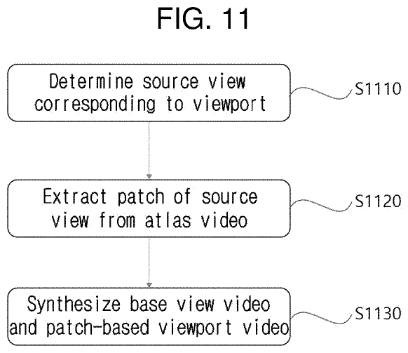

FIG. 11 is a flowchart illustrating a process of synthesizing a viewport video.

When a viewing position of a user is input, at least one source view necessary for generating a viewport video suitable for the viewing position of a user may be determined (S1110). For example, when a viewport is located between a first view x₁ and a second view x₂, the first view x₁ and the second view x₂ may be determined as source views for viewport video synthesis.

When a source view thus determined is a shared view, a reference additional view of the shared view may also be determined as a source view for viewport video synthesis.

A metadata processor 230 may determine at least one base view corresponding to a viewing position of a user and at least one of an additional view or a shared view by analyzing metadata.

When a source view is determined, it is possible to extract residual data that are derived from a source view determined based on an atlas video (S1120). Specifically, after a source view of patches in an atlas video is confirmed, patches that are source views, of which a source is determined, may be extracted from the atlas video.

When residual data are extracted, a viewport video may be synthesized based on the extracted residual data and a base view video (S1130). Specifically, a viewport video may be generated by warping a base view video and a residual video to a coordinate system of a viewing position and adding the warped reference videos. Here, a position/size of residual data (for example, patch) may be parsed in metadata.

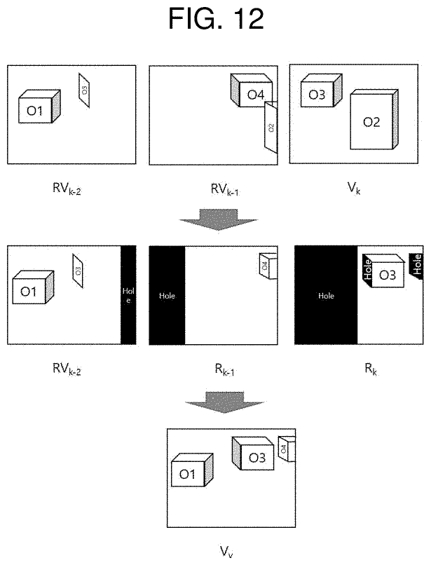

FIG. 12 is a view illustrating an example of synthesizing a viewport video by using a base view video and patches.

A viewport video Vᵥ corresponding to a viewing position xᵥ of a user may be generated by synthesizing a base view video Vₖ, a residual video RVₖ₋₁ for a reference view video Vₖ₋₁, a residual video RVₖ₋₂ for an additional view video Vₖ₋₂.

First, a reference video Rₖ may be generated by warping a base view video Vₖ to the coordinate system of an additional view xᵥ. An object O3 in a reference video Rₖ is mapped as its position is determined according to depth. Although an object O2 is also mapped according to the coordinate system of a view xₖ₋₂, since it is not included in a viewport (that is, a view xᵥ), it is not included in a viewport video Vᵥ.

Next, a texture of a region that is unseen in a base view video Vₖ but seen in a view xᵥ should be generated. For this, with reference to a three-dimensional geometric relationship, a suitable view for bringing a texture, which is left as a hole in a reference video Rₖ, through backward warping, is determined. In FIG. 12, a view xₖ₋₁ and a view x_{K-2} are illustrated as reference views for backward warping.

Information of patches is extracted from metadata, and patches derived from a view xₖ₋₁ and a view xₖ₋₂ are extracted based on the extracted information. When patches are extracted, the extracted patches are warped to a view vₖ. For example, a reference view Rₖ₋₁ and a reference video Rₖ₋₂ are generated by warping a residual video RVₖ₋₁ of a view xₖ₋₁ and a residual video RVₖ₋₂ of a view xₖ₋₂ according to the coordinate system of a view xᵥ. Then, data to be inserted into a texture that is left as a hole in a reference video Rₖ are extracted from data included in a reference video Rₖ₋₁ and a reference video Rₖ₋₂.

For example, data for an object O4, which is left as a hole in a reference video Rₖ, may be extracted from a reference video Rₖ₋₁, and data for the left side of an object O3, which is left as a hole, and data for an object O1, which is left as a hole, may be extracted from a reference video Rₖ₋₂.

As the above-described example, a residual video of an additional view may be generated by removing duplicate data with a base view video and/or duplicate data with an additional reference view video. Here, duplicate data of reference view videos may be removed through a hierarchical comparison.

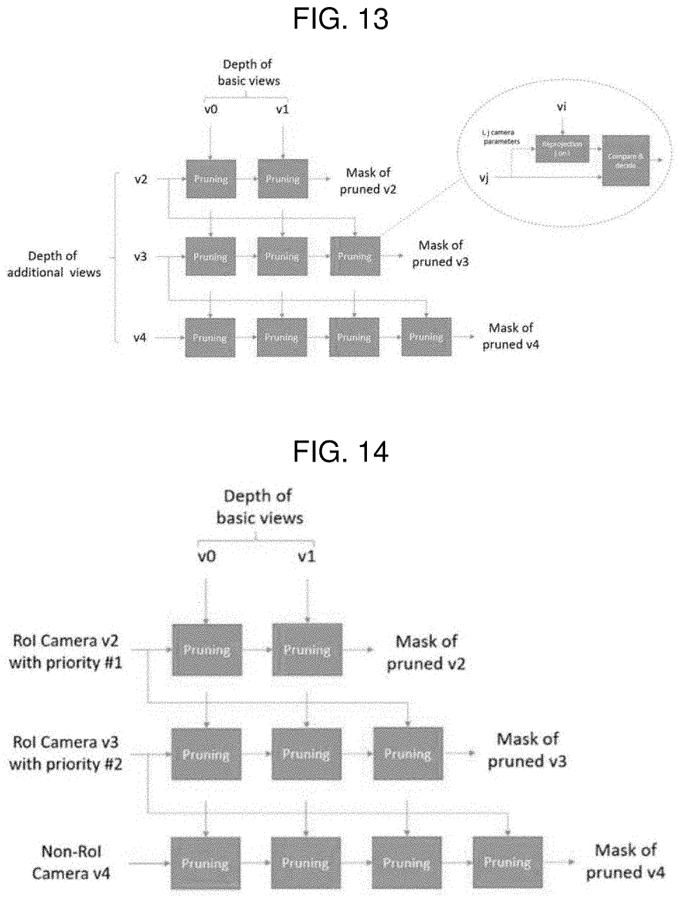

FIG. 13 is a view illustrating an example of performing hierarchical pruning among additional view videos.

In FIG. 13, V0 and V1 represent base view videos, and V2 to V4 represent additional view videos.

As for the order of priority among the additional view videos, it is assumed that V2 has the highest priority followed by V3 and V4.

Residual data of an additional view video with a low priority may be generated by removing duplicate data with a base view video and an additional view video with a higher priority.

For example, residual data for an additional view video V2 with the highest priority may be generated by removing duplicate data with base view videos V0 and V1. On the other hand, residual data for an additional view video V3 with a lower priority than an additional view video V2 may be generated by removing duplicate data with a base view video V0, a base view video V1 and the additional view video V2. Residual data for an additional view video 4 with the lowest priority may be generated by removing duplicate data with a base view video V0, a base view video V1, an additional view video V2 and another additional view video V3.

Based on a pruning order of additional view videos, the number or form of residual data (for example, patch) may be differently determined. Specifically, it is highly probable that relatively more residual data are generated for an additional view video with a high priority (or an additional view video with a front place in pruning order) but relatively less residual data are generated for an additional view video with a low priority (or an additional view video with a back place in pruning order).

For example, based on the example illustrated in FIG. 13, the volume of residual data stored is very likely to be large for an additional view video V2 with the first place in pruning order in an atlas video since pruning is performed by using only a base view video.

On the other hand, the volume of residual data stored is very likely to be small for an additional view video V4 with the last place in pruning order since pruning is performed by using not only a base view video but also additional view videos V2 and V3.

As a smaller volume of residual data is stored, quality degradation is more likely to occur when a viewport video is generated by using a corresponding view.

For example, when a viewport video is intended to be generated based on a view x₂, it may be generated by synthesizing residual data of a base view video V0, a base view video V1 and an additional view video V2. On the other hand, when a viewport video around a view x4 is intended to be generated, it is necessary to synthesize residual data of not only base view videos V0 and V1 but also additional view videos V2, V3 and V4. In other words, a viewport video in a view x₂ can be actually generated by synthesizing three source view videos (V0, V1 and V2), while a viewport video in a view x4 is actually generated by synthesizing five source view videos (V0, V1, V2, V3 and V4). Accordingly, it may be expected that a viewport video in a view x4 has a lower quality than a viewport video in a view x₂.

By reflecting the above-described characteristic, a pruning order may be determined so that more residual data of a ROI region can be stored.

Specifically, a user normally views a region where an object is located rather than the background in the entire region of an immersive video. Based on such a viewing pattern, a user's main viewing position in an entire viewing region may be designated as a ROI (Region of Interest). ROI may be set by a producer or an operator. When a ROI is set, information on the ROI may be encoded as metadata.

When a ROI is set, a multiplicity of cameras may be distinguished into ROI cameras and non-ROI cameras. Based on the above classification, source view videos may also be distinguished into ROI view videos and non-ROI view videos. Specifically, a ROI view video may show a source view video captured based on a ROI camera, and a non-ROI view video may show a source view video captured based on a non-ROI camera.

Hereinafter, a view video corresponding to a ROI will be referred to as a ROI video. A ROI video may be generated by synthesizing patches that are extracted from a base view video and/or a ROI view video.

In order to enhance the quality of a ROI video, a pruning priority for a ROI view video may be set to be higher than a pruning priority of a non-ROI view video.

FIG. 14 is a view illustrating a pruning order for a ROI view video and a non-ROI view video.

As in the example illustrated in FIG. 14, an additional view video V2 and an additional view video V3, which are captured through ROI cameras, may be pruned earlier than an additional view video V4 captured through a non-ROI camera.

In case there is a multiplicity of ROI view videos, a pruning order among the multiplicity of ROI view videos may be determined based on at least one among importance of a source view video, a priority order among ROI cameras, and camera indexes.

For example, in the example illustrated in FIG. 14, a ROI view video V2 has a higher pruning priority than another ROI view video V3.

An atlas video may be generated by packing residual data (for example, patch) of a multiplicity of additional view videos. The total number of atlas videos may be variously determined according to the arrangement of camera rigs or the accuracy of depth maps.

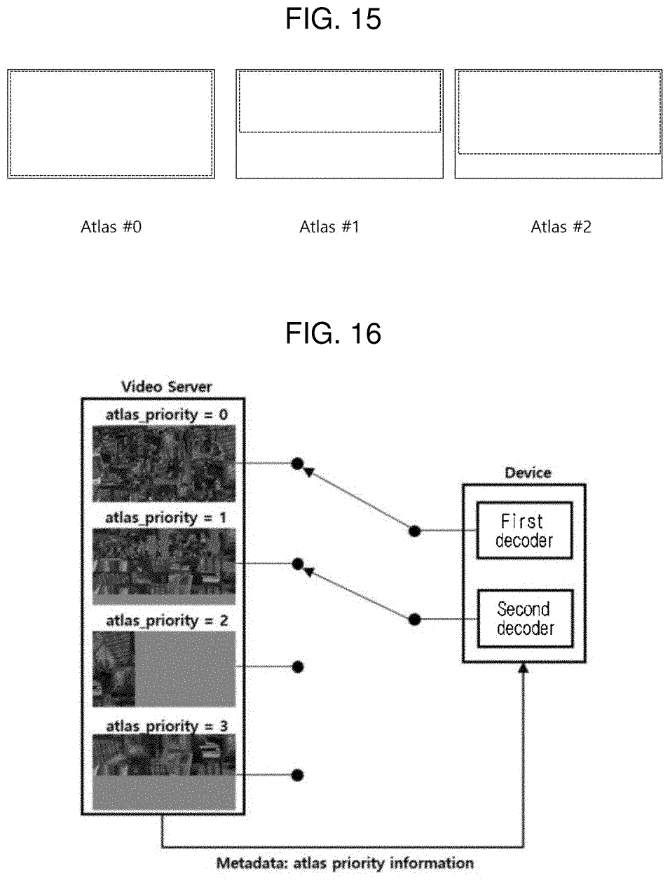

FIG. 15 illustrates an example where a multiplicity of atlas videos is generated.

In FIG. 15, dotted lines represent a region occupied by patches that are included in an atlas video.

In case a multiplicity of atlas videos is generated, an immersive video output apparatus should be also equipped with a multiplicity of decoders. However, if the number of decoders mounted in an immersive video output apparatus is smaller than the number of atlas videos, not all the atlas videos may be decoded.

Even if not all the atlas videos can be decoded, an order of priority among the atlas videos may be set in order to enable view video synthesis for a main view. An order of priority among atlas videos may be encoded as metadata.

In case the number of decoders is smaller than the number of atlas videos, an immersive video output apparatus may determine an atlas video to be decoded, on the basis of an order of priority among atlas videos. Specifically, an atlas video with a high priority may be selected as a decoding target.

FIG. 16 is a view illustrating an example where an atlas video to be decoded is selected according to a priority order of atlas videos.

In case the number of decoders mounted in an immersive video output apparatus is smaller than the number of atlas videos, the immersive video output apparatus may determine an atlas video to be decoded, on the basis of an order of priority among atlas videos. A higher priority means a higher degree of necessity for decoding.

For example, an atlas video may be determined by parsing information on a priority order among atlas videos and then using the parsed information.

For example, when the number of decoders for parsing atlas videos is 2, two atlas videos with higher priority among atlas videos may be determined as decoding targets. In the example illustrated in FIG. 16, an atlas video with the priority 0 (atlas_priority=0) is input into a first decoder, and an atlas video with the priority 1 (atlas_priority=1) is input into a second decoder.

An order of priority among atlas videos may be determined based on at least one of the number of ROI patches included in an atlas video or the size of a region occupied by ROI patches in an atlas video.

A ROI patch indicates a patch that is derived from a ROI view video. For example, the highest priority may be allocated to an atlas video with the largest number of ROI patches, and the lowest priority may be allocated to an atlas video with the smallest number of ROI patches.

In case there is a multiplicity of ROI view videos, the highest priority may be allocated to an atlas video including the largest volume of residual data of a ROI video with the highest priority (for example, in a pruning order) among a multiplicity of ROI view videos.

Table 1 presents a structure of an atlas parameter list atlas_params_list including a syntax atlas_priority showing a priority order among atlas videos.

TABLE 1

Descriptor

atlas_params_list( ) {

| | |
|---|---|
| num_atlases_minus1 | u(8) |
| for (i = 0; i <= num_atlases_minus1; i++) { | |

| | |
|---|---|
| atlas_id[i]; | u(8) |
| atlas_priority[i]; | u(8) |
| atlas_params(atlas_id[i]) | |

}

}

In Table 1, the syntax num_atlases_minus1 represents a value that is obtained by subtracting 1 from the number of atlas videos. When the syntax num_atlases_minus1 is larger than 0, it means that there is a multiplicity of atlas videos.

The syntax atlas_id[i] represents an index of the i-th atlas video. A different index may be allocated to each atlas video.

The syntax atlas_priority[i] represents a priority of the i-th atlas video. Specifically, the syntax atlas_priority[i] indicates an atlas video to be preferred when a video output apparatus does not have a sufficient capacity to decode every atlas video. As the syntax atlas_priority[i] has a lower value, a decoding priority is higher. The priority of each atlas video may have a different value. Alternatively, the priority of a multiplicity of atlas videos may be set to the same value.

Although ROI patches are dispersedly packed in a multiplicity of atlas videos, if only some of the multiplicity of atlas videos can be decoded, the remaining undecoded atlas videos may cause a problem that ROI videos are not fully synthesized. In order to such a problem, ROI patches may be packed in one atlas video.

Alternatively, non-ROI patches may be packed after ROI patches are packed in an atlas video. Here, ROI patches may be consecutively arranged within a predetermined space. In other words, ROI patches may be set to cluster in a predetermined region.

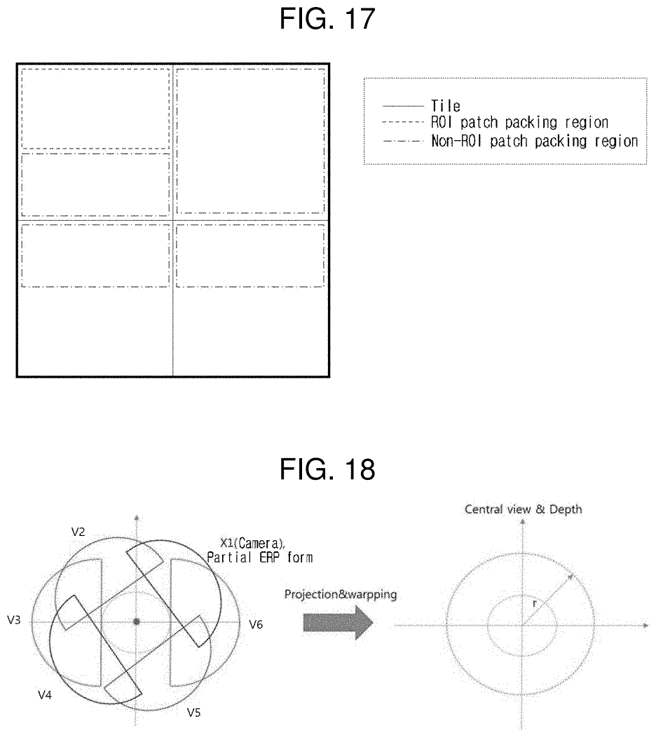

FIG. 17 is a view illustrating an aspect of packing ROI patches in an atlas video.

As the example illustrated in FIG. 17, after consecutively packing ROI patched in a predetermined region within an atlas video, patches of non-ROI may be packed in the residual space of the atlas video.

Packing of ROI patches may be performed in tiles. For example, until a tile is filled, ROI patches may be packed in the tile. In case there is no space left in the tile for packing ROI patches, ROI patches may be packed in the next tile.

Information for identifying a region where ROI patches are packed may be encoded as metadata. For example, at least one of the information indicating the position of a region, where ROI patches are packed, or the information indicating the size of a region, where ROI patches are packed, may be encoded.

Table 2 presents a structure of an atlas parameter list atlas_params_list including syntaxes indicating the size of a region where ROI patches within an atlas video are packed.

TABLE 2

Descriptor

atlas_params_list( ) {

| | |
|---|---|
| num_atlases_minus1 | u(8) |
| for (i = 0; i <= num_atlases_minus1; i++) { | |

| | |
|---|---|
| atlas_id[i]; | u(8) |
| roi_width_in_atlas[i]; | u(8) |
| roi_height_in_atlas[i]; | u(8) |
| atlas_params(atlas_id[i]) | |

}

}

The syntax roi_width_in_atlas[i] represents the width of a region including ROI patches within the i-th atlas video.

The syntax roi_height_in_atlas[i] represents the height of a region including ROI patches within the i-th atlas video.

Table 3 presents a structure of an atlas parameter list atlas_params_list including syntaxes indicating a position where ROI patches within an atlas video are packed.

TABLE 3

Descriptor

atlas_params_list( ) {

| | |
|---|---|
| num_atlases_minus1 | u(8) |
| for (i = 0; i <= num_atlases_minus1; i++) { | |

| | |
|---|---|
| atlas_id[i]; | u(8) |
| roi_pos_in_atlas_x[i]; | u(8) |
| roi_pos_in_atlas_y[i]; | u(8) |
| atlas_params(atlas_id[i]) | |

}

}

The syntax roi_pos_in_atlas_x[i] represents the x-coordinate of a region including ROI patches within the i-th atlas video.

The syntax roi_pos_in_atlas_y[i] represents the y-coordinate of a region including ROI patches within the i-th atlas video.

Here, x-coordinate and y-coordinate indicated by the syntaxes may be at least one among the top left, top right, bottom left, bottom right and central coordinates of a region including ROI patches.

Unlike the examples of Table 2 and Table 3, information for identifying a tile including ROI patches may be signaled. For example, the syntax roi_num_tile_in_atlas[i] or the syntax roi_tile_id_in_atlas[i] may be encoded.

The syntax roi_num_tile_in_atlas[i] represents the number of tiles including ROI patches within the i-th atlas video.

The syntax roi_tile_id_in_atlas[i] represents an index of a tile including ROI patches within the i-th atlas video.

In order to reduce the number of atlas videos or a bit rate for an atlas video, an atlas video may be generated by downsampling a patch and packing the downsampled patch. By using a downsampled patch, the data volume of a patch itself may be reduced, and a space occupied by patches within an atlas video may be reduced.

In an immersive video output apparatus, a patch that is extracted from an atlas video to represent a viewport video may be upsampled. Information for upsampling of a patch may be encoded and then be transmitted as metadata.

Table 4 presents a structure of an atlas parameters atlas_params including syntaxes indicating a reduction ratio of patch.

TABLE 4

Descriptor

atlas_params(a) {

| | |
|---|---|
| num_patches_minus1[ a] | u(16) |
| for (i = 0; i <= num_patches_minus1; i++) { | |

| | |
|---|---|
| view_id[ a][i] | u(8) |
| patch_width_in_view[ a][i] | u(16) |
| patch_height_in_view[ a][i] | u(16) |
| patch_pos_in_atlas_x[ a][i] | u(16) |
| patch_pos_in_atlas_y[ a][i] | u(16) |
| patch_width_in_atlas_x[ a][i] | u(16) |
| patch_height_in_atlas_y[ a][i] | u(16) |
| patch_pos_in_view_x[ a][i] | u(16) |
| patch_pos_in_view_y[ a][i] | u(16) |
| patch_rotation[ a][i] | u(8) |

}

In Table 4, the syntax num_patches_minu1[a] represents a value that is obtained by subtracting 1 from the number of patches included in an atlas video with index a.

The syntax view_id[a][i] specifies a source view of the i-th patch within an atlas video. For example, when view_id[a][i] is 0, it means that the i-th patch is the residual data of a source view video V0.

The syntax patch_width_inview[a][i] indicates the width of the i-th patch within a source view video. The syntax patch_height_in_view[a][i] indicates the height of the i-th patch within a source view video. The size of a patch may be determined based on a luma sample.

The syntax patch_width_in_atlas[a][i] indicates the width of the i-th patch within an atlas video. The syntax patch_height_in_atlas[a][i] indicates the height of the i-th patch within an atlas video. The size of a patch may be determined based on a luma sample.

The syntax pos_in_view_x[a][i] indicates the x-axis of the i-th patch within a source view video, and the syntax pos_in_view_y[a][i] indicates the y-axis of the i-th patch within a source view video.

The syntax pos_in_atlas_x[a][i] indicates the x-axis of the i-th patch within an atlas video, and the syntax pos_in_atlas_y[a][i] indicates the y-axis of the i-th patch within an atlas video.

The syntax patch_rotation[a][i] indicates whether or not the i-th patch is rotated or mirrored while it is packed.

A scale factor of a patch may be derived by comparing the size of the patch in a source view video and the size of the patch in an atlas video. A scale factor may indicate an expansion/reduction ratio.

For example, if it is assumed that a patch is not rotated while packing, a horizontal scale factor may be derived by comparing the syntax patch_width_in_view[a][i] and the syntax patch_width_in_atlas[a][i], and a vertical scale factor may be derived by comparing patch_height_in_view[a][i] and patch_height_in_atlas[a][i]. For example, when the value of patch_width_in_view[a][i] is 400 pixels and the value of patch_width_in_atlas[a][i] is 200 pixels, it means that the width is reduced to ½ while the i-th patch is packed. Accordingly, a horizontal scale factor may be set as ½. Thus, an immersive video processor may perform upsampling that expands the width of a patch twice during viewport video synthesis.

In case a patch is rotated 90 degrees clockwise or counter-clockwise, a scale factor for horizontal direction may be derived by comparing patch_width_inview[a][i] and patch_height_in_atlas[a][i], and a scale factor for vertical direction may be derived by comparing patch_height_in_view[a][i] and patch_height_in_atlas[a][i].

For another example, a syntax indicating a ratio between a patch size in a source view video and a patch size in an atlas video may also be encoded. For example, Table 5 presents a structure of atlas parameters atlas_params including syntaxes indicating a ratio between a patch size in a source view video and a patch size in an atlas video.

TABLE 5

Descriptor

atlas_params(a) {

| | |
|---|---|
| num_patches_minus1[ a] | u(16) |
| for (i = 0; i <= num_patches_minus1; i++) { | |

| | |
|---|---|
| view_id[ a][i] | u(8) |
| patch_width_in_view[ a][i] | u(16) |
| patch_height_in_view[ a][i] | u(16) |
| patch_pos_in_atlas_x[ a][i] | u(16) |
| patch_pos_in_atlas_y[ a][i] | u(16) |
| patch_width_scale_factor_in_atlas_x[ a][i] | u(16) |
| patch_height_scale_factor_in_atlas_y[ a][i] | u(16) |
| patch_pos_in_view_x[ a][i] | u(16) |
| patch_pos_in_view_y[ a][i] | u(16) |
| patch_rotation[ a][i] | u(8) |

}

In Table 5, the syntax patch_width_scale_factor_in_atlas_x[a][i] indicates a syntax for deriving a scale factor of horizontal direction for the i-th patch. The syntax patch_width_scale_factor_in_atlas_y[a][i] indicates a syntax for deriving a scale factor of vertical direction for the i-th patch.

A width of the i-th patch within an atlas video may be derived by multiplying a width of the i-th patch within a source view video by a scale factor of horizontal direction and a scale factor of vertical direction. A height of the i-th patch within an atlas video may be derived by multiplying a height of the i-th patch within a source view video by a scale factor of horizontal direction and a scale factor of vertical direction.

Although Table 5 shows that a scale factor of horizontal direction and a scale factor of vertical direction are signaled respectively, a single scale factor commonly applicable to both horizontal direction and vertical direction may also be signaled. For example, the syntax patch_size_scale_factor_in_atlas[a][i] indicating a scale factor of horizontal and vertical directions may be encoded.

In Table, syntaxes indicating the size of the i-th patch within a source view video and a syntax for determining a scale factor are encoded. For another example, syntaxes indicating the size of the i-th patch within an atlas video and a syntax for determining a scale factor may be encoded. In this case, the width/height of the i-th patch within a source video may be derived by multiplying the width/height of the i-th patch within an atlas video by a scale factor.

After patches are divided into a multiplicity of patch groups, patches of a patch group may be set to be downsampled at the same ratio. A scale factor of a patch may be determined by determining a scale factor of each patch group and specifying a patch group to which the patch belongs.

Table 6 presents a structure of atlas parameter atlas_params including a syntax for identifying a patch group to which a patch belongs.

TABLE 6

Descriptor

atlas_params(a) {

| | |
|---|---|
| num_patches_minus1[ a] | u(16) |
| for (i = 0; i <= num_patches_minus1; i++) { | |

| | |
|---|---|
| view_id[ a][i] | u(8) |
| patch_width_in_view[ a][i] | u(16) |
| patch_height_in_view[ a][i] | u(16) |
| patch_pos_in_atlas_x[ a][i] | u(16) |
| patch_pos_in_atlas_y[ a][i] | u(16) |
| patch_pos_in_view_x[ a][i] | u(16) |
| patch_pos_in_view_y[ a][i] | u(16) |
| patch_rotation[ a][i] | u(8) |
| patch_scaling_group_id[ a][i] | u(8) |

}

In Table 6, the syntax patch_scaling_group_id[a][i] indicates an index of a patch group including the i-th patch. A scale factor of a patch group indicated by patch_scaling_group_id[a][i] may be determined as the scale factor of the i-th patch.

For example, it is assumed that patches included in a patch group 0 are packed without downsampling and patches included in a patch group 1 are reduced by ½ in width and ⅓ in height. In case the syntax patch_scaling_group_id[a][i] is 0, upsampling may not performed for the i-th patch. On the other hand, in case the syntax patch_scaling_group_id[a][i] is 1, upsampling may be performed to expand the i-th patch twice in the horizontal direction and three times in the vertical direction.

Based on whether or not a patch is a ROI patch, it may be determined whether or not to perform downsampling when packing a patch. For example, a ROI patch may be packed in an atlas video with no change in its original size. On the other hand, a smaller patch than an original size may be packed in an atlas video by performing downsampling for a non-ROI patch.

Alternatively, based on whether or not a patch is a ROI patch, a downsampling rate may be determined. For a ROI patch, a width and/or height may be reduced by a first scale factor. On the other hand, for a non-ROI patch, a width and/or height may be reduced by a second scale factor. Here, a first scale factor may be a larger real number than a second scale factor.

Metadata indicating whether or not a patch is a ROI patch may be encoded and transmitted. For example, Table 7 presents a structure of atlas parameters atlas_params including a syntax indicating whether or not a patch is a ROI patch.

TABLE 7

Descriptor

atlas_params(a) {

| | |
|---|---|
| num_patches_minus1[ a] | u(16) |
| for (i = 0; i <= num_patches_minus1; i++) { | |

| | |
|---|---|
| view_id[a][i] | u(8) |
| roi_patch_flag [a][i] | u(1) |
| patch_width_in_view[a][i] | u(16) |
| patch_height_in_view[a][i] | u(16) |
| patch_pos_in_atlas_x[a][i] | u(16) |
| patch_pos_in_atlas_y[a][i] | u(16) |
| patch_pos_in_view_x[a][i] | u(16) |
| patch_pos_in_view_y[a][i] | u(16) |
| patch_rotation[a][i] | u(8) |

}

In Table 7, the syntax roi_patch_flag[a][i] indicates whether or not the i-th patch is a ROI patch. For example, when the value of the syntax roi_patch_flag[a][i] is 1, the i-th patch is a ROI patch. For example, when the value of the syntax roi_patch_flag[a][i] is 0, the i-th patch is a non-ROI patch.

A syntax indicating whether or not an atlas video includes a ROI patch may be encoded. For example, the syntax roi_patch_present_flag[i] indicating whether or not the i-th atlas video includes a ROI patch through an atlas parameter list atlas_params_list may be encoded.

Based on whether or not an atlas video includes a ROI patch, an order of priority among atlas videos may be determined. For example, an atlas video including a ROI patch may have a higher decoding priority than an atlas video with no ROI patch.

An atlas video may have the same size as other videos. Alternatively, different sizes may be set for an atlas video and other videos. Here, other videos are encoded together with an atlas video. They may mean a source view video or a base view video.

Alternatively, different sizes may be set for an atlas texture video and an atlas depth video. In this case, other videos for an atlas depth video may mean an atlas depth video.

An atlas video with a reduced size may be encoded/decoded by performing scaling for the atlas video. For example, by applying scaling to at least one of an atlas texture video or an atlas depth video, the atlas texture video with a reduced size or the atlas depth video with a reduced size may be encoded/decoded.

In case the size of an atlas video is reduced, patches included in the atlas video are also reduced to the same degree. Accordingly, in order to synthesize a view video by using patches included in an atlas video, the atlas video or the patches should be expanded to the same degree as the atlas video is reduced.

For this, information on scaling of an atlas video may be encoded as metadata.

For example, it is possible to encode scale-related information of an atlas video in a high-level syntax such as a sequence parameter set (SPS) or a picture parameter set (PPS).

Scale-related information of an atlas video may include at least one of information indicating whether or not an atlas video is scaled or information on the size of the atlas video.

For example, scaling-related information of an atlas video may be encoded into an atlas_params_list or into atlas parameters atlas_parms.

Table 8 presents a structure of an atlas parameter list atlas_params_list including scaling-related information of an atlas video.

TABLE 8

Descriptor

atlas_params_list( ) {

| | |
|---|---|
| num_atlases_minus1 | u(8) |
| atlas_scale_flag | u(1) |
| If(stals_flag_flag==1) { | |

| | |
|---|---|
| atlas_width | u(16) |
| atlas_height | u(16) |

}
for (i = 0; i<= num_atlas_minus1; i++) {

| | |
|---|---|
| atlas_id[i]; | u(8) |
| atlas_params(atlas_id[i]) | |

}

}

In Table 8, the syntax atlas_scale_flag indicates whether or not scaling is performed for an atlas video. Here, an atlas video may represent at least one of an atlas texture video or an atlas depth video.

When the syntax atlas_scale_flag is 1, it means that an atlas video is encoded by being reduced or scaling for the atlas video is allowed. When the syntax atlas_scale_flag is 1, an atlas video and other videos may have different sizes.

When the syntax atlas_scale_flag is 1, information indicating the size of an atlas video may be encoded. For example, the syntax atlas_width indicates a width of an atlas video, and the syntax atlas_height indicates a height of an atlas video.

Table 9 presents a structure of atlas parameters atlas_params including scaling-related information of an atlas video.

TABLE 9

Descriptor

atlas_params(a) {

| | |
|---|---|
| num_patches_minus1[a] | u(16) |
| depth_atlas_scale_flag[a] | u(1) |
| If(depth_atlas_scale_flag==1) { | |

| | |
|---|---|
| atlas_width[a] | u(16) |
| atlas_height[a] | u(16) |

}
for (i = 0; i <= num_patches_minus1; i++) {

| | |
|---|---|
| view_id[a][i] | u(8) |
| patch_width_in_view[a][i] | u(16) |
| patch_height_in_view[a][i] | u(16) |
| patch_pos_in_atlas_x[a][i] | u(16) |
| patch_pos_in_atlas_y[a][i] | u(16) |
| patch_pos_in_view_x[a][i] | u(16) |
| patch_pos_in_view_y[a][i] | u(16) |
| patch_rotation[a][i] | u(8) |

}

In Table 9, the syntax depth_atlas_scale_flag indicates whether or not an atlas video is scaled. For example, depth_atlas_scale_flag indicates whether or not an atlas video including depth information (for example, an atlas depth video) is scaled.

When an atlas video is scaled, information indicating the width and height of the scaled atlas video may be signaled. For example, the syntax atlas_width[a] indicates a width of an atlas video with index a, and the syntax atlas_height[a] indicates a height of an atlas video with index a. Here, the syntax atlas_width[a] and the syntax atlas_height[a] may indicate a size of either an atlas texture video or an atlas depth video according to the type of a scaled atlas video.

An atlas video may include a texture video and/or a depth video. Here, scaling may be allowed only for an atlas depth video.

Alternatively, scaling may be applied both to an atlas texture video and to an atlas depth video, or scaling may be applied only one of an atlas texture video or an atlas depth video.

Information indicating whether or not scaling is performed for an atlas texture video and an atlas depth video respectively may be signaled through a bit stream. For example, depth_atlas_scale_flag indicating whether or not an atlas depth video is scaled and texture_atlas_scale_flag indicating whether or not an atlas texture video is scaled may be signaled respectively.

A scale factor between an atlas texture video and an atlas depth video may be differently set. In this case, information indicating a size of an atlas texture video and information indicating a size of an atlas depth video may be signaled respectively.

By comparing a size of an atlas video and a size of a different video, a scale factor for the atlas video may be derived. Specifically, a scale factor for horizontal direction may be derived by comparing a width of an atlas video and a width of a different video, and a scale factor for vertical direction may be derived by comparing a height of an atlas video and a height of a different video.

When a scale factor is derived, an atlas video or a patch extracted from the atlas video may be reconstructed into an original size on the basis of the derived scale factor.

For another example, information indicating a scale factor of an atlas video may be signaled. For example, the syntax atlas_width_scale_factor_x[a] indicates a scale factor of an atlas video with index a in the horizontal direction. The syntax atlas_width_scale_factor_y[a] indicates a scale factor of an atlas video with index a in the vertical direction.

In case a multiplicity of atlas videos is encoded, all the atlas videos may be scaled with the same size. Accordingly, a multiplicity of atlas videos may have a size specified by the syntax atlas_width and the syntax atlas_height.

Alternatively, each of a multiplicity of atlas videos may have different scale factors. Thus, information indicating a size of atlas video may be signaled in each atlas video. For example, the syntax atlas_width[i] and the syntax atlas_height[i] may be signaled. The syntaxes indicate the width and height of the i-th atlas video.

A flag indicating whether or not scaling for an atlas video is allowed may be signaled in a higher level, and information indicating the size of atlas video may be signaled in a lower level.

For example, the syntax atlas_scale_flag indicating whether or not an atlas video has a different size from another video through an atlas parameter list atlas_params_list may be signaled through a bit stream. When the syntax atlas_scale_flag is 0, it means that an atlas video has the same size as a different video. When the syntax atlas_scale_flag is 1, it means that an atlas video may have a different size from other videos.

The syntaxes atlas_width[i] and atlas_height[i], which indicate the size of the i-th atlas video, may be signaled through atlas_params including parameters for the i-th atlas video. Here, whether or not to parse the syntax atlas_width[i] and the syntax atlas_height[i] may be determined by the value of syntax atlas_scale_flag signaled through a higher level (that is, atlas parameter list atlas params_list). For example, when the syntax atlas_scale_flag is 1, the syntax atlas_width[i] and the syntax atlas_height[i] may be parsed.

In case the syntax atlas_width and the syntax atlas_height are not encoded, the size of an atlas video may be regarded as the same as another video.

Alternatively, the syntax scale_enabled_flag indicating whether or not scaling for an atlas video is allowed may be signaled through a parameter set including video sequence parameters, and the syntax atlas_width and the syntax atlas_height indicating the size of an atlas video may be encoded through an atlas parameter list atlas_params_list.

In case there is a multiplicity of atlas videos, the syntaxes atlas_width and atlas_height signaled through an atlas parameter list may indicate the sizes of a multiplicity of altas videos.

Source view videos with a deviation for x-axis or y-axis may be obtained through camera in different positions. Based on parallax among cameras, depth information may be inferred from source view videos, which are 2D videos. Accordingly, 3D space information may be reconstructed from source view videos, which are 2D videos, and videos in a 3D space may be reproduced. In order to reproduce a video of a 3D space based on a base view video and an atlas video, positional information of cameras used for capturing each source view video needs to be provided. Accordingly, positional information of each camera may be encoded and transmitted as metadata.

Here, if there is no distance difference for the x-axis and/or y-axis direction among cameras, the positional information for the x-axis and/or y-axis direction may be encoded only for one camera among a multiplicity of cameras. For example, since cameras arranged in a form of 1D array (for example, cameras in 1x5 structure) or cameras arranged in a form of 2D array (for example, cameras in 4x4 structure) are located on the same straight line or plane, there may be no difference of distance for the x-axis or y-axis direction among cameras. In case there is no difference of distance for the x-axis or y-axis direction among cameras, encoding information on positions of cameras on the x-axis or y-axis may be skipped.

Table 10 presents a structure of a camera parameter list camera_params_list including syntaxes for determining a camera position.

TABLE 10

Descriptor

camera_params_list( ) {

| | |
|---|---|
| num_cameras_minus1 | u(16) |

| | |
|---|---|
| cam_pos_x_present_flag | u(1) |
| cam_pos_y_present_flag | u(1) |

for (i= 0; i <= num_cameras_minus1;i++){

| | |
|---|---|
| cam_id[i] | u(16) |

If(cam_pos_x_present_flag)

| | |
|---|---|
| cam_pos_x[i] | u(32) |

If(cam_pos_y_present_flag)

| | |
|---|---|
| cam_pos_y[i] | u(32) |
| cam_pos_z[i] | u(32) |
| cam_yaw[i] | u(32) |
| cam_pitch[i] | u(32) |
| cam_roll[i] | u(32) |

| | |
|---|---|
| } | |
| intrinsic_params_equal_flag | u(1) |
| for (i = 0; i<= intrinsic_params_equal_flag ? 0 : num_cameras_minus1;i++) | |

camera_intrinsics([i])

| | |
|---|---|
| depth_quantization_params_equal_flag | u(1) |
| for (i = 0; i <= depth_quantization_equal_flag ? 0 : | |

num_cameras_minus1;i++)

depths_quantization([i])

}

In Table 10, the syntax num_cameras_minus1 represents a value that is obtained by subtracting 1 from the number of cameras.

The syntax cam_id[i] represents an index of the i-th camera. The syntax cam_id[i] may be connected with the syntax view_id[i] indicating an index of a source view (refer to Table 4 to Table 7). In other words, when the value of view_id[i] is n, it may mean that a patch is generated from a source view video captured by a camera of which cam_id[i] is n.

The syntax cam_pos_x_present_flag indicates whether or not there is a difference of distance for the x-axis direction (for example, front-back direction) among cameras. When the syntax cam_pos_xpresent_flag is 0, it means that there is no difference of distance for the x-axis direction among cameras. In this case, encoding the syntax cam_pos_x[i] indicating a position of a camera on an x-axis may be skipped. When the syntax cam_pos_x_present_flag is 1, at least one among cameras has a different position on an x-axis. When the syntax cam_pos_x_present_flag is 1, the syntax cam_pos_x[i] indicating an x-axis position of each camera may be encoded.

The syntax cam_pos_y_present_flag indicates whether or not there is a difference of distance for the y-axis direction (for example, up-down direction) among cameras. When the syntax cam_pos_ypresent_flag is 0, it means that there is no difference of distance for the y-axis direction among cameras. In this case, encoding the syntax cam_pos_y[i] indicating a position of a camera on a y-axis may be skipped. When the syntax cam_pos_y_present_flag is 1, at least one among cameras has a different position on a y-axis. When the syntax cam_pos_y_present_flag is 1, the syntax cam_pos_y[i] indicating a y-axis position of each camera may be encoded.

The syntax intrinsic_params_equal_flag indicates whether or not cameras have a same intrinsic parameter. When the syntax intrinsic_params_equal_flag is 1, an intrinsic parameter may be signaled only for a first camera. An intrinsic parameter of the remaining cameras may be set to be the same as the first camera. When the syntax intrinsic_params_equal_flag is 0, an intrinsic parameter may be signaled for each camera.

In the above-described embodiment, at least one among a multiplicity of source view videos is set as a base view video. For another example, based on a multiplicity of source view videos, a view video of a specific view may be synthesized and then the synthesized view video may be set as a base view video.

For example, based on a multiplicity of source view videos, a view video of a central view may be synthesized and then the synthesized central view video may be set as a base view video. Here, a central view may represent a center of a sphere, a central view video may be a video in full ERP (Equi-Rectangular Projection) based on the central view. After a multiplicity of source view videos is warped to a central view of a sphere, a central view video may be generated by merging warped videos. A central view video may include a texture video and/or a depth video.

FIG. 18 is a view illustrating an example of generating a central view video.

In a semi-ERP immersive video, as illustrated in FIG. 18, source view videos obtained by each camera may be partial ERP videos constituting parts of the immersive video.

Here, a central view video may be generated by merging source view videos. For example, as illustrated in FIG. 18, after source view videos V1 to V6 are projected and/or warped to a center of a sphere, a central view video may be generated by merging the projected and/or warped source view videos.

A central view video may be a full ERP video that is generated by merging partial ERPs.

A central view video may be set as a base view video, and pruning between the base view video and additional view videos may be performed. Specifically, by removing duplicate data between a synthesized central view video and an additional view video, a residual video of a source view video may be removed.

The number of prunings may be equal to or greater than the number of additional view videos. However, as the number of prunings increases, a data throughput in an immersive video processor increases. In order to solve this problem, the present invention proposes a method of reducing the number of prunings. Specifically, the number of prunings may be reduced by synthesizing a multiplicity of additional view videos and performing pruning by using the synthesized additional view videos.

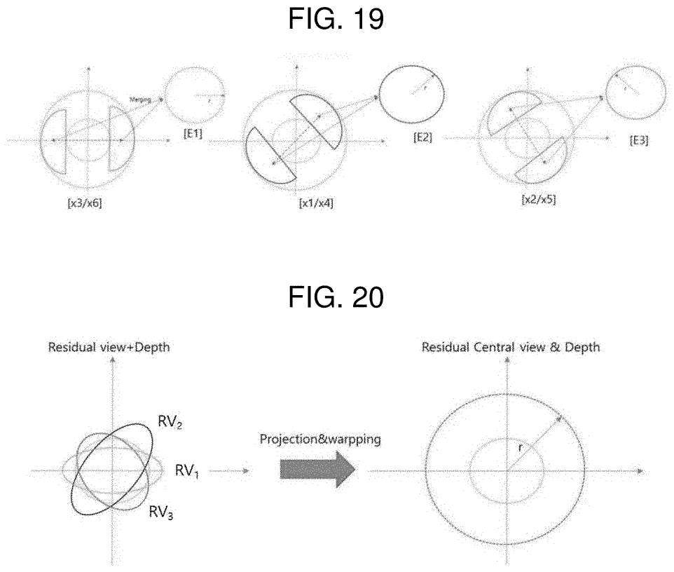

FIG. 19 is a view illustrating a method of synthesizing additional view videos according to the present invention.

In order to reduce the number of prunings, a multiplicity of source view videos may be merged. Specifically, a full ERP additional view video may be obtained by merging two or more partial ERP videos or by merging additional view videos with symmetrical views. A merged additional view video may include a texture video and/or a depth video.

For example, as illustrated in FIG. 19, a full ERP additional view video may be generated by merging source view videos captured through symmetrical cameras. For example, an additional view video E1 may be generated by merging symmetrical source view videos V3 and V6. An additional view video E2 may be generated by merging symmetrical source view videos V1 and V4, and an additional view video E3 may be generated by merging symmetrical source view video V2 and V5.

Residual data for merged additional view videos may be generated by performing pruning between a central view video and merged additional view videos. The number of videos, which are input for pruning, may be reduced by using merged additional view videos for pruning, instead of source view videos.

Residual data for an additional view video may be generated by projecting and/warping a central view video to a position of a merged additional view video. For example, a residual video RV 1 for an additional view video E1 may be generated by removing duplicate data between a central view video and the merged additional view video E1. A residual video RV2 for an additional view video E2 may be generated by removing duplicate data between a central view video and the merged additional view video E2. A residual video RV3 for an additional view video E3 may be generated by removing duplicate data between a central view video and the merged additional view video E3. A residual video may include a residual video for a texture video and a residual video for a depth video.

When residual videos are generated, a central view residual video may be generated by synthesizing the generated residual videos on the basis of a central view. Duplicate data among residual videos may be removed by generating a central view residual video.

FIG. 20 is a view illustrating an example of generating a residual central view video.

In the example illustrated in FIG. 20, a residual video RV1, a residual video RV2, and a residual video RV3 may be projected and/warped based on a center of a sphere. A central view residual video may be generated by merging projected and/or warped residual videos.

A central view residual video may be projected and/warped to a position of a merged additional view video E_{N}. A second residual video RV′_{N} may be generated based on a residual video RV_{N} of an additional view video E_{N}, which is merged with a projected and/or warped central view residual video.

A second residual video may be generated by masking a residual video of a merged additional view video to a projected and/or warped central view residual video, or by subtracting a residual video of a merged additional view video from a projected and/or warped central view residual video.

For example, a second residual video RV′₁ for a merged additional view video E1 may be generated based on a residual video RV₁ of an additional view video E1 that is merged with a projected and/or warped central view residual video.

When a second residual video is generated, an atlas video may be generated by packing residual data of the second residual video. Specifically, an atlas video may be generated by making residual data within a second residual video into a square form and by packing patches into one video.

Duplicate data among residual videos may be effectively removed by generating an atlas video on the basis of a central view residual video instead of each residual video.

Here, when a ROI is designated within a video frame, packing may be performed by considering whether or not residual data are included in the ROI. Specifically, ROI patches may be packed into a first region of an atlas region, and non-ROI patches may be packed into a second region of an atlas region. In other words, packing regions for ROI patches and non-ROI patches may be separated.

The position of a ROI may be determined through partition based on regions within a video frame. When a ROI is designated, data of the ROI may be preferentially sent for sending and receiving data. For example, whether or not to preferentially send a ROI may be determined according to network or terminal characteristics.

When ROI patches and non-ROI patches are packed in different regions, information for packing may be encoded as metadata. For example, the metadata may include at least one among information whether or not ROI patches are packed in separate regions, information on region type within an atlas region (for example, whether ROI patches are packed or non-patches are packed), positional information of ROI (for example, identifier or position of ROI), information on the number/size of ROIs, and information on a priority order or packing order for ROIs/non-ROIs.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The above-described embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks and magnetic tapes; optical data storage media such as CD-ROMs and DVD-ROMs; magneto-optimum media like floptical disks; and hardware devices, such as read-only memory (ROM), random-access memory (RAM), flash memory, etc., which are particularly structured to store and implement program instructions. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. An immersive video processing method, the method comprising:
classifying a multiplicity of source view videos into base view videos and additional view videos;
generating residual data for the additional view videos;
packing a patch, which is generated based on the residual data, into an atlas video, and
generating metadata for the patch,
wherein the metadata comprise information for identifying a source view, which is a source of the patch, or information indicating a position of the patch in the atlas video.

2. The method of claim 1,
wherein the metadata further comprise a flag indicating whether or not the patch is a ROI (Region of Interest) patch.

3. The method of claim 1,
wherein the metadata comprises index information of cameras capturing the multiplicity of source view videos, and
different indexes are allocated to each of the cameras.

4. The method of claim 1,
wherein, when a multiplicity of atlas videos is generated, the metadata comprise priority information of the atlas videos.

5. The method of claim 1,
wherein the metadata comprise information indicating positions where ROI patches in the atlas videos are packed.

6. The method of claim 1,
wherein the metadata further comprise at least one of a flag indicating whether or not the atlas videos are scaled or information indicating the size of the atlas videos.

7. The method of claim 6,
wherein, when a multiplicity of atlas videos is encoded, the flag is encoded for each of the atlas videos.

8. An immersive video synthesizing method, the method comprising:
parsing video data and metadata from a bit stream;
decoding the video data; and
synthesizing a viewport video on the basis of a base view video and an atlas video generated by decoding the video data,
wherein the metadata comprise information for identifying a source view of a patch comprised in the atlas video or information indicating the position of the patch in the atlas video.

9. The method of claim 8,
wherein the metadata further comprise a flag indicating whether or not the patch is a ROI (Region of Interest) patch.

10. The method of claim 8,
wherein the metadata comprise index information of cameras capturing the multiplicity of source view videos, and
different indexes are allocated to each of the cameras.

11. The method of claim 8,
wherein, when there is a multiplicity of atlas videos and the number of decoders is smaller than the number of atlas videos,
whether or not the atlas videos are decoded is determined based on priority information of the atlas videos comprised in the metadata.

12. The method of claim 8,
wherein the metadata comprise information indicating positions where ROI patches in the atlas videos are packed.

13. The method of claim 8,
wherein the metadata comprise at least one of a flag indicating whether or not the atlas videos are scaled or information indicating the size of the atlas videos.

14. The method of claim 12,
wherein, when a multiplicity of atlas videos is encoded, the flag is parsed for each of the atlas videos.
